(19) United States
(12) Patent Application Publication
(10) Pub. No.: US 2017/0227558 A1
(43) Pub. Date: Aug. 10, 2017

(54) NUCLEIC ACID ANALYSIS DEVICE AND DEVICE DIAGNOSIS METHOD FOR NUCLEIC ACID ANALYSIS DEVICE

(71) Applicant: HITACHI HIGH-TECHNOLOGIES CORPORATION, Tokyo (JP)

(72) Inventors: Manami Nammoku, Tokyo (JP); Yasunori Shoji, Tokyo (JP)

(73) Assignee: HITACHI HIGH-TECHNOLOGIES CORPORATION, Tokyo (JP)

(21) Appl. No.: 15/315,429

(22) PCT Filed: May 20, 2015
(86) PCT No.: PCT/JP2015/064396

§ 371 Date: Dec. 1, 2016

(30) Foreign Application Priority Data
Jun. 13, 2014 (JP) 2014-121972

(51) Int. Cl. G01N 35/02; B01L 7/00; G01N 35/00

(52) U.S. Cl. CPC G01N 35/025; G01N 35/00712; B01L 7/52; G01N 2035/00326; G01N 2035/00366; G01N 2035/00376; B01L 2200/143; B01L 2200/147; B01L 2300/1822

(57) ABSTRACT

An object of the invention is to provide a method by which failure or performance deterioration of a temperature adjustment unit can be detected while specifying a cause part in a state where a nucleic acid amplification process is being performed. In order to achieve said purpose, an initial value of the level of control signals input to a temperature adjustment element during temperature maintenance, temperature rise, and temperature fall is set in advance and an error determination threshold is set on the basis of this value. Errors (malfunctions, performance deterioration) in the temperature adjustment unit are diagnosed and components causing said errors are identified, by comparing current control signal levels and threshold values monitored in a state in which the nucleic acid amplification process is being undertaken.

### TECHNICAL FIELD

The present invention relates to a nucleic acid analysis device which analyzes a biological sample by amplifying nucleic acid contained in the biological sample, and a device diagnosis method for the nucleic acid analysis device.

### BACKGROUND ART

The analysis of nucleic acid contained in a biological sample, such as blood, blood plasma, and a piece of tissue, is carried out not only in academic researches such as biology, biochemistry, and medicine, but also in various fields such as diagnosis, cultivar improvement of crops, and industries of food inspection. The most widely used method as an analysis method for nucleic acid is a technique called a polymerase chain reaction (PCR), by which nucleic acid in the analysis target area is subjected to base sequence-specific amplification. In the PCR, the following cycles are repeated 30 to 40 times. That is, reaction solution containing nucleic acid and reagents for amplifying the nucleic acid is heated to about 95° C. such that the nucleic acid is thermally denatured, and then the solution is cooled to about 60° C. such that annealing and extension reaction of the nucleic acid are promoted. As a means for detecting the amplification of nucleic acid associated with the progress of the reaction, in many cases, it is conducted by mixing the reaction solution with fluorescent labels of which fluorescence intensity changes depending on the amount of PCR products, irradiating the mixed solution with excitation light, and measuring the fluorescence intensity emitted from the fluorescent labels.

PTL 1 discloses a technique in which the malfunction of a temperature adjustment unit is diagnosed by measuring the AC resistance of a thermoelectric element (peltier device). It is empirically determined that a thermoelectric element which shows an increase of about 5% in the AC resistance after temperature cycles of about 20,000 times to about 50,000 times fails in a short period of time. When a device is started up or an operator conducts a dedicated self-diagnosis function, the malfunction diagnosis is performed by equalizing the temperatures of a heating surface and a cooling surface of the thermoelectric element and then measuring the AC resistance.

### CITATION LIST

### Patent Literature

PTL 1: JP 2008-278896 A

### SUMMARY OF INVENTION

### Technical Problem

However, in the method of PTL 1, it is necessary to equalize the temperatures of both surfaces of the thermoelectric element (peltier device) to perform the diagnosis. Thus, when failure occurs in the temperature adjustment unit during measurement of specimens (during temperature cycling for amplifying nucleic acid), the diagnosis cannot be performed. In addition, since the diagnosis is conducted on the basis of an increase in the resistance caused by fatigue failure of the peltier device, there is a problem in that it is not possible to diagnose the malfunction of components other than the peltier device in the temperature adjustment unit.

An object of the invention is to provide a method by which failure or performance deterioration of a temperature adjustment unit can be detected while specifying a cause part in a state where a nucleic acid amplification process is being performed.

### Solution to Problem

As the method for achieving the object described above, an initial value of the level of control signals input to a temperature adjustment element during temperature maintenance, temperature rise, and temperature fall is set in advance and an error determination threshold is set on the basis of this value. The monitored current control signal level and the threshold are compared in a state where the nucleic acid amplification process is being performed, whereby failure (malfunction and performance deterioration) of the temperature adjustment unit is diagnosed, and further, a component causing the failure is specified.

### Advantageous Effects of Invention

Failure or performance deterioration of the temperature adjustment unit can be detected by using the diagnosis method of the invention while specifying a cause part in a state where a nucleic acid amplification process is being performed.

### BRIEF DESCRIPTION OF DRAWINGS

FIG. 1 is a top view illustrating a configuration example of main parts in a nucleic acid analysis device according to a first embodiment of the invention.

FIG. 2 is a cross-sectional view illustrating a configuration example taken along line A-A′ of FIG. 1.

FIG. 3 is a schematic view illustrating a detailed configuration example of a temperature adjustment unit in the nucleic acid analysis device of FIGS. 1 and 2.

FIG. 4 is a top view illustrating a schematic configuration example of a nucleic acid analysis device according to a second embodiment of the invention.

FIG. 5 is a diagram illustrating an example of the temperature of a temperature adjustment block and the level of control signals input to a peltier device.

FIG. 6 is a diagram illustrating an example of the temperature of a temperature adjustment block and the level of control signals input to the peltier device when the peltier device fails.

FIG. 7A is a diagram illustrating the relationship between the combination of the temperature of the temperature adjustment block and the level of control signals input to the peltier device and failure of a component which can be determined by the combination.

FIG. 7B is a diagram illustrating the relationship between the combination of the temperature of the temperature adjustment block and the level of control signals input to the peltier device and failure of a component which can be determined by the combination.

FIG. 7C is a diagram illustrating the relationship between the combination of the temperature of the temperature adjustment block and the level of control signals input to the peltier device and failure of a component which can be determined by the combination.

FIG. 7D is a diagram illustrating the relationship between the combination of the temperature of the temperature adjustment block and the level of control signals input to the peltier device and failure of a component which can be determined by the combination.

FIG. 7E is a diagram illustrating the relationship between the combination of the temperature of the temperature adjustment block and the level of control signals input to the peltier device and failure of a component which can be determined by the combination.

FIG. 8 is a table summarizing the relationship between the combination of the temperature of the temperature adjustment block and the level of control signals input to the peltier device and failure of a component which can be determined by the combination.

FIG. 9 is a diagram illustrating a method for diagnosing temperature adjustment performance failure from the level of control signals input to peltier devices of a plurality of temperature adjustment units.

### DESCRIPTION OF EMBODIMENTS

When the PCR reaction is performed, accuracy of the temperature adjustment performance is significantly important. In the step of performing thermal denaturation of nucleic acid, when the temperature becomes excessively high beyond 95° C., there is a concern that a nucleic acid amplification enzyme is deactivated and amplification efficiency is reduced. When the temperature is out of the appropriate temperature during annealing, primers cannot be appropriately annealed to the target sequence, and thus the amount of target amplification products is reduced. In addition, when failure occurs in the temperature adjustment performance after the reaction solution obtained by mixing target nucleic acid to be analyzed with reagents or the like is formulated and the PCR reaction is started by the nucleic acid analysis device, the analysis is invalid and specimens are wasted. For this reason, it is preferable that failure of the temperature adjustment unit in the device be detected before specimens are measured, and it is further preferable that the failure be detected in the stage before the temperature adjustment performance goes completely wrong, that is, at the stage of deterioration. Furthermore, it is preferable that the failed component be specified so as to promptly perform repairing.

Hereinafter, a nucleic acid analysis device according to the invention will be described in detail with reference to the accompanying drawings.

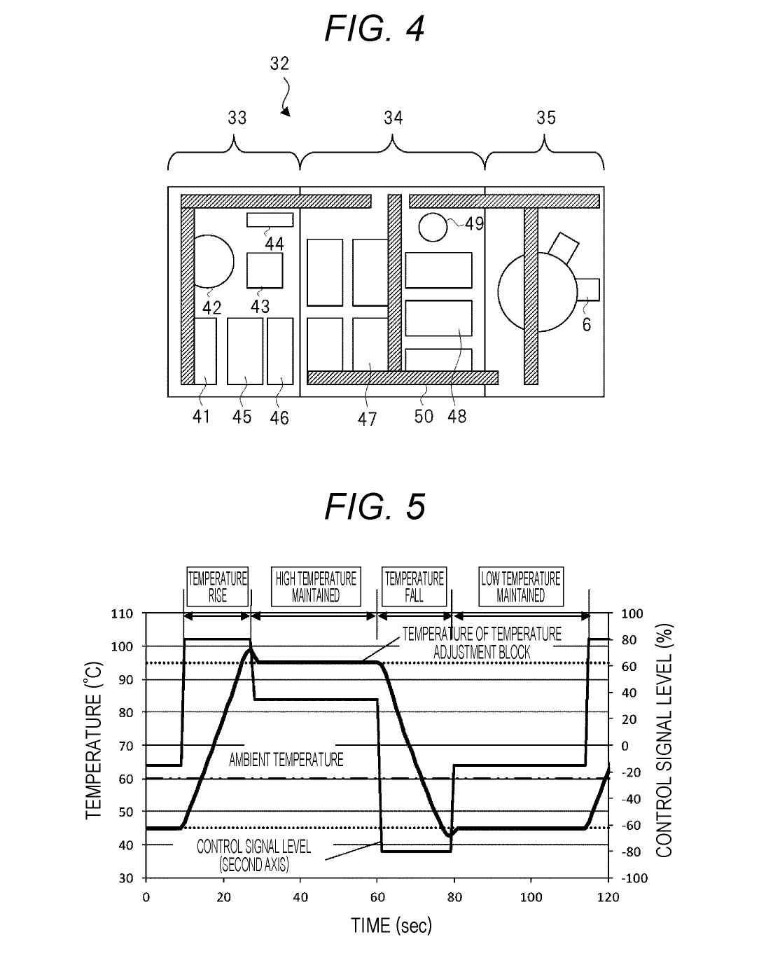

FIG. 4 is a top view illustrating a schematic configuration example of the nucleic acid analysis device. A nucleic acid analysis device 32 of FIG. 4 includes a nucleic acid extraction unit 33 that extracts nucleic acid from specimens, a reagent mixing unit 34 that dispenses reagents to the extracted nucleic acid and mixes them, and a nucleic acid analysis unit 35 that adjusts the temperature of the mixed reaction solution and detects the fluorescence thereof. The nucleic acid analysis unit 35 among these units is an essential component of the nucleic acid analysis device. However, the nucleic acid extraction unit 33 and the reagent mixing unit 34 are not essential components, and any combination of the units may be employed. Hereinafter, the diagnosis method of the nucleic acid analysis unit 35 will be described in detail.

### First Embodiment

### [Configuration of Main Parts of Nucleic Acid Analysis Device]

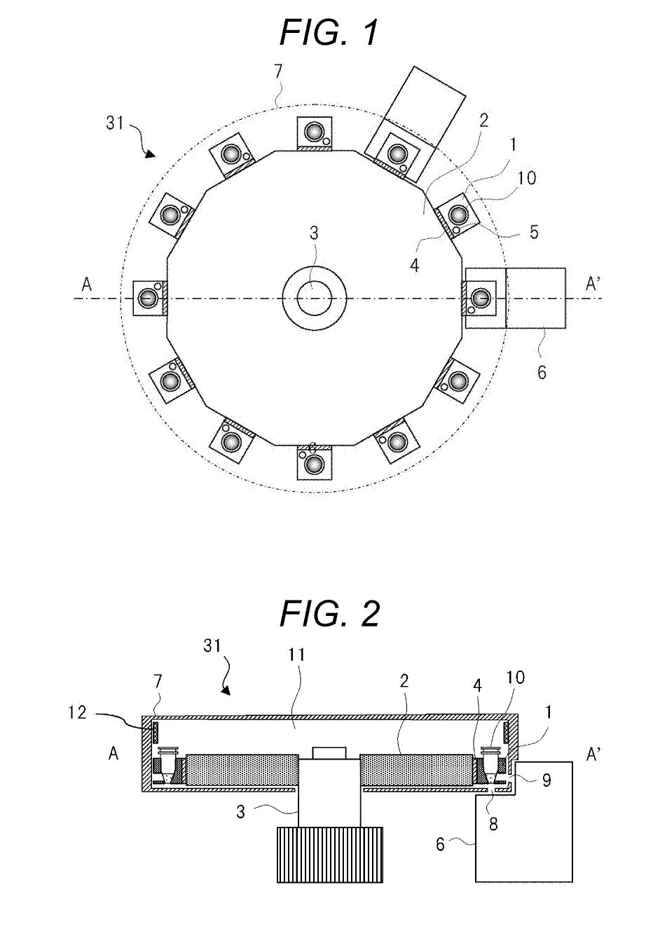

FIG. 1 is a top view illustrating a configuration example of main parts in a nucleic acid analysis device according to a first embodiment of the invention. FIG. 2 is a cross-sectional view illustrating a configuration example taken along line A-A′ of FIG. 1

The configuration of a nucleic acid analysis unit 31 of FIGS. 1 and 2 is similar to that of the nucleic acid analysis unit 35 of FIG. 4, and includes a temperature adjustment block 1, a carousel 2, a peltier device 4, a temperature sensor 5, a photometer 6, a shielding plate 7, and a heater 12.

A plurality of (twelve in this example) temperature adjustment blocks 1 is disposed along the outer circumference of the carousel 2 around the central axis thereof and rotationally driven around a rotation shaft 3. The peltier devices (temperature adjustment element) 4 are respectively disposed between the plurality of temperature adjustment blocks 1 and the carousel 2. The temperature of the temperature adjustment block 1 is adjusted by controlling the peltier device 4 while monitoring the temperature of the temperature adjustment block 1 using the temperature sensor 5 installed in the temperature adjustment block 1. A set of the peltier device 4 and the temperature sensor 5 is disposed corresponding to each of the plurality of temperature adjustment blocks 1, and thus the temperatures of the plurality of temperature adjustment blocks 1 are independently adjusted.

The photometer 6 is disposed on the outer circumference of the carousel 2. In this case, for example, two photometers 6, which use light of different wavelengths, are illustrated. However, one or three or more photometers 6 may be disposed as long as it is disposed on the outer circumference of the carousel 2. All of the temperature adjustment blocks 1 move on the same circumference by rotational driving. Therefore, when the temperature adjustment blocks 1 pass through the front of the photometer 6, the relative positions between the photometer 6 and the temperature adjustment blocks 1 are the same for all of the temperature adjustment blocks 1.

The plurality of temperature adjustment blocks 1 is covered, together with the carousel 2, by the shielding plate 7 so as to reduce the optical disturbance at the time of analyzing the temperature adjustment blocks 1 by the photometer 6. When the analysis is conducted, a tube (reaction container) 10 containing reaction solution (sample) obtained by mixing nucleic acid with reagents or the like is held by the temperature adjustment block (holding member) 1. An excitation light irradiation window 8 for receiving excitation light from the photometer 6 and a fluorescence detection window 9 through which the photometer 1 captures fluorescence are provided in each temperature adjustment block 1. In this case, the excitation light irradiation window 8 is disposed on the lower surface of the temperature adjustment block 1 and the fluorescence detection window 9 is disposed on the side surface of the temperature adjustment block 1. However, the arrangement of the windows can be freely set in accordance with the structure of a photometer.

It is preferable that a shielding plate inner portion 11 be maintained at the same temperature so as to minimize an influence on the temperature adjustment block 1 by changes in the external air temperature outside the shielding plate. Therefore, a temperature sensor (not illustrated) and the heater 12 are installed in the inner portion of the shielding plate 7. In this case, the heater 12 is disposed on the side surface on the inner side of the shielding plate 7. However, the heater 12 may be disposed at any position of the shielding plate inner portion 11 in accordance with the structure. Furthermore, various heat sources such as peltier devices and a heat radiator such as a fan and a fin can be used in addition to a heater, and a plurality of these may be combined.

### [Details of Temperature Adjustment Unit]

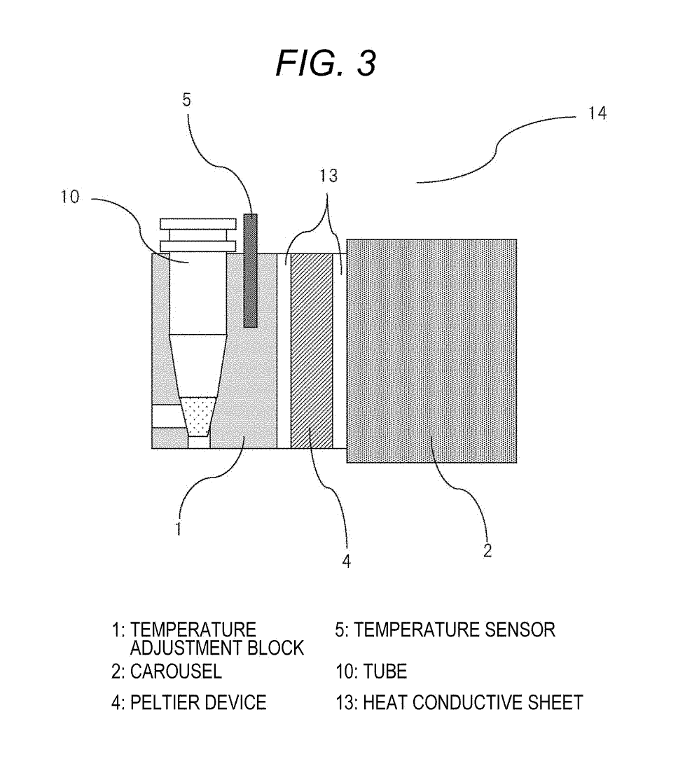

FIG. 3 is a view illustrating the detail of a temperature adjustment unit 14. The temperature adjustment unit 14 includes the temperature adjustment block 1 that holds the tube 10 in which the reaction solution containing nucleic acid is stored, the peltier device 4 that adjusts the temperature of the temperature adjustment block 1, the temperature sensor 5 that monitors the temperature of the temperature adjustment block 1, and a heat conductive sheet 13. To improve heat conductivity, the heat conductive sheet 13 is interposed between the contact surfaces between the heat radiating surface and the cooling surface of the peltier device and the temperature adjustment block 1 or the carousel 2. Grease or the like may be applied instead of the heat conductive sheet 13. In addition, a fixing tool (not illustrated) may be used to fix the temperature adjustment block 1 to the carousel 2.

FIG. 5 is a diagram schematically illustrating the combination of the temperature of the temperature adjustment block 1 at the time of temperature cycling in which the temperature of the temperature adjustment block 1 repeatedly changes between 95° C. to 45° C. under the condition of the ambient temperature of 60° C. and the level of control signals input to the peltier device 4 at this time in the temperature adjustment unit 14 of FIG. 3. In terms of the control signal level, on the basis of the surface of the peltier device 4 in contact with the temperature adjustment block, the control signal level at the time of heating is indicated from 0% to 100% and the control signal level at the time of cooling is indicated from 0% to −100%. The larger the absolute value of the number, the stronger the heating/cooling power.

It is preferable that, when temperature cycling for nucleic acid amplification is performed, the speed of temperature rise/temperature fall be set to a constant value (for example, 1° C./sec, etc.) in advance. The reason for this is as follows. The same temperature cycling is always performed, and thus variations in the results between the measurements can be reduced and, when the nucleic acid amplification process is performed, the process can be finished on the expected finish time schedule. Therefore, it is possible to easily plan the analysis schedule.

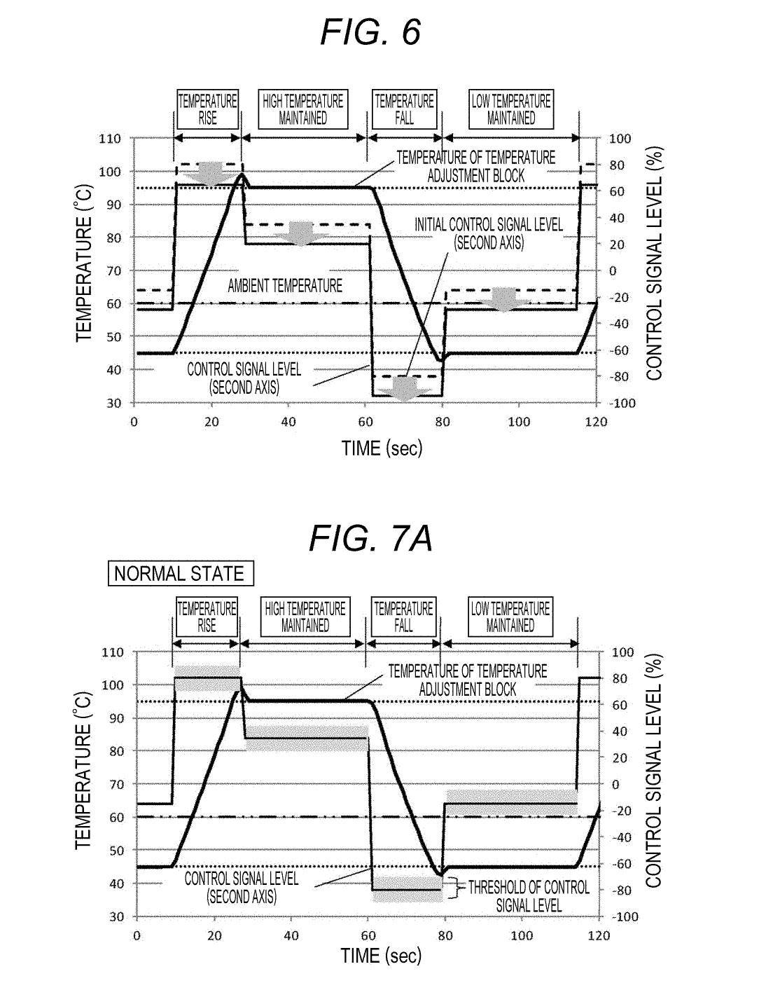

FIG. 6 is a diagram schematically illustrating an example of the temperature of the temperature adjustment block 1 and the level of control signals input to the peltier device 4 when the peltier device 4 is deteriorated. When the deterioration of a peltier device progresses by repeatedly rising and falling the temperature thereof, the electrical resistance of the peltier device is increased, and thus Joule heat is increased during operation. Therefore, as compared to the initial state, heating becomes advantageous and cooling becomes disadvantageous. In other words, when the speed of temperature rise/temperature fall is controlled to become a certain value, the control signal level for heating at the time of temperature rise is smaller than that of the initial state and the control signal level for cooling at the time of temperature fall is greater than that of the initial state.

For the same reason, not only the control signal level of temperature rise/temperature fall but also the control signal level for heating/cooling at the time of constant temperature maintenance changes from the initial value. For example, when the temperature of the shielding plate inner portion 11 is 60° C., the peltier device 4 is heated when the temperature of the temperature adjustment block 1 is maintained at 95° C. and the peltier device 4 is cooled when the temperature of the temperature adjustment block 1 is maintained at 45° C. Similarly to the case of temperature rise/temperature fall, when the peltier device 4 is deteriorated, the control signal level for heating at the time of maintaining the temperature higher than that of the shielding plate inner portion 11 is smaller than that of the initial state and the control signal level for cooling at the time of lower temperature maintenance is greater than that of the initial state.

When changes in the control signal level described above are used, deterioration or failure of the peltier device 4 can be diagnosed. First, the level of control signals input to the peltier device 4 at each stage of temperature cycling is tuned for each peltier device 4 before device shipment and the initial values are stored into the device. Since the temperature of the shielding plate inner portion 11 changes even when the temperature adjustment is performed, an error diagnosis threshold is set by giving likelihood to the initial values, and it is diagnosed as failure when a value deviates from this range.

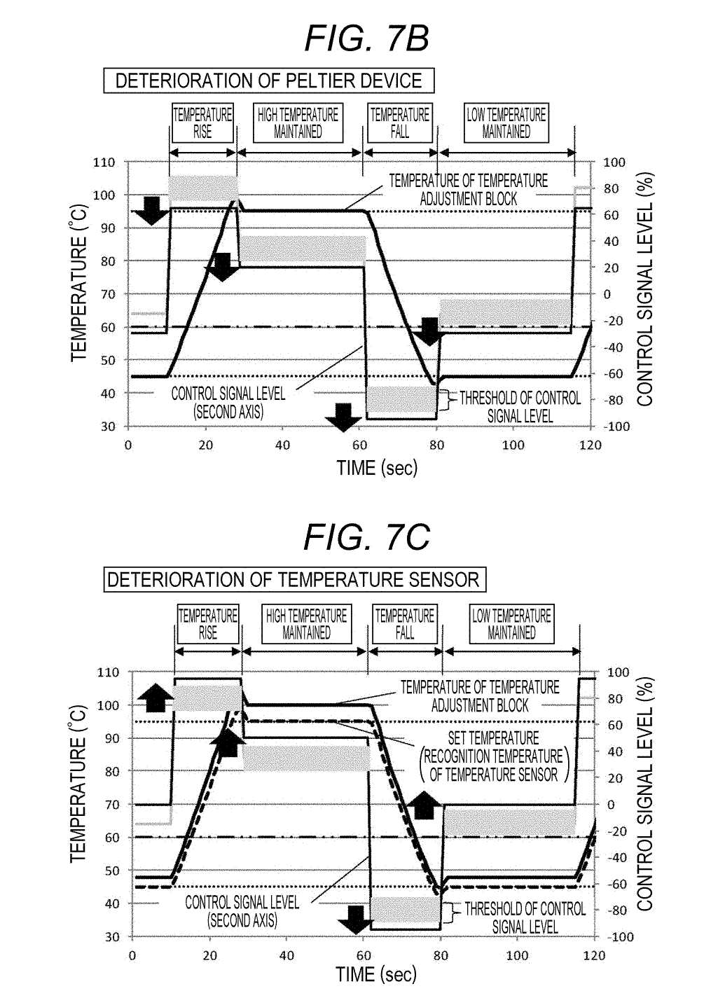

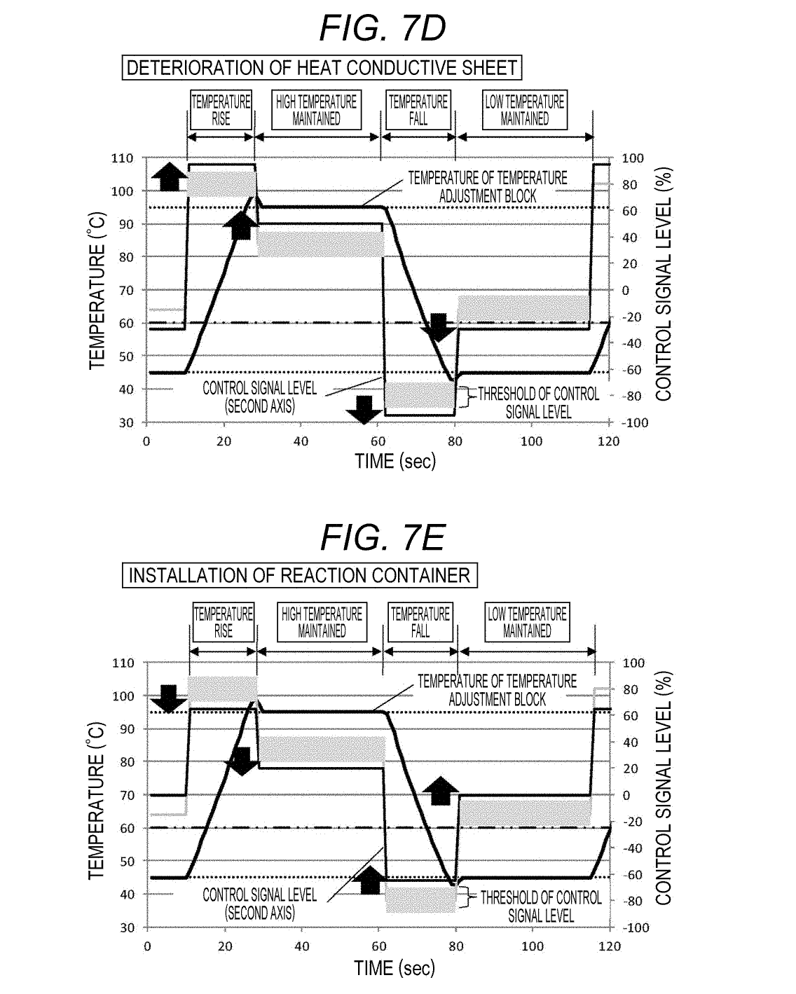

FIG. 7A is a diagram illustrating the normal state of the temperature adjustment unit 14. FIG. 7A schematically illustrates FIG. 5. The level of control signals for heating/cooling input to the peltier device 4 is within the range of the threshold set on the basis of the initial values over all the stages of temperature cycling. In this case, it is diagnosed that the temperature adjustment unit 14 is in a normal state.

FIG. 7B is a diagram illustrating the case where the peltier device 4 is deteriorated. FIG. 7B schematically illustrates FIG. 6. During temperature rise and maintaining the temperature higher than the temperature of the shielding plate inner portion 11, the control signal level for heating is smaller than the threshold. On the contrary, during temperature fall and maintaining the temperature lower than the temperature of the shielding plate inner portion 11, the control signal level for cooling is greater than the threshold. In this case, it is diagnosed that the temperature adjustment unit 14 is in a failed state, and further, it is diagnosed that the failed portion is the peltier device 4.

Similarly, deterioration of the temperature sensor 5 and the heat conductive sheet 13, in addition to the peltier device 4, can also be diagnosed from changes in the level of control signals input to the peltier device 4.

FIG. 7C is a diagram illustrating the case where the temperature sensor 5 is deteriorated. When insulating properties of a temperature sensor are reduced due to fatigue, the temperature is recognized as the value lower than the actual temperature. In other words, the actual temperature of the temperature adjustment block 1 is the temperature higher than the preset temperature (the recognition temperature by the temperature sensor 5). Therefore, when the temperature is maintained higher than the temperature of the shielding plate inner portion 11, the control signal level for heating is greater than the threshold and, when the temperature is maintained lower than the temperature of the shielding plate inner portion 11, the control signal level for cooling is smaller than the threshold. In addition, since the phenomenon of reduction in insulating properties becomes remarkable as the temperature is rising, the temperature change range at the time of temperature rise/temperature fall is increased as compared to that in the normal state. Therefore, to keep the speed of temperature rise/temperature fall constant, both the control signal level for heating at the time of temperature rise and the control signal level for cooling at the time of temperature fall are greater than the threshold. In this case, it is diagnosed that the temperature adjustment unit 14 has failed, and further, it is diagnosed that the failed portion is the temperature sensor 5.

FIG. 7D is a diagram illustrating the case where the heat conductive sheet 13 is deteriorated. The thermal conductivity of the heat conductive sheet 13 is reduced due to aging deterioration, and thus it is difficult for changes in the temperature of the peltier device 4 to be transmitted to the temperature adjustment block 1. Therefore, the control signal level for heating/cooling is greater than the threshold over all stages of temperature cycling. In this case, it is diagnosed that the temperature adjustment unit 14 has failed, and further, it is diagnosed that the failed portion is the heat conductive sheet 13.

The diagnosis method described above can also be used for detecting failure other than deterioration of a component. FIG. 7E is a diagram illustrating the case where the installation of the tube 10 is not performed normally. The heat capacity of the temperature adjustment block 1 is reduced as compared to that in a normal state, and thus the peltier device 4 can perform temperature maintenance or temperature changes with less output. Therefore, the control signal level for heating/cooling is smaller than the threshold over all stages of temperature cycling. In such a case, it is diagnosed that failure has occurred in an installation state of the tube 10.

Since the success or failure of the installation of the tube 10 significantly affects the PCR results, it is normally monitored by a dedicated sensor. However, it is undeniable that there is also a possibility of malfunction of the sensor. To prepare for such a case, dual monitoring can be performed by this diagnosis.

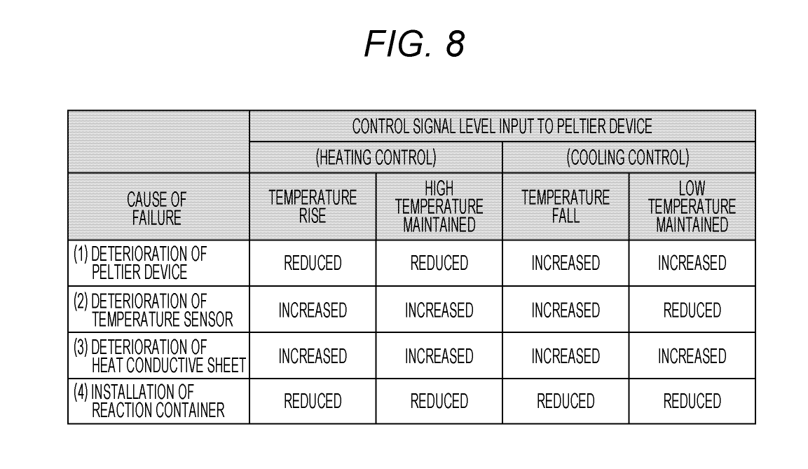

FIG. 8 summarizes the relationship between the level of control signals for heating/cooling input to the peltier device and a cause of failure specified thereby. Failure occurring in the temperature adjustment performance of the device can be promptly diagnosed and the cause part (the peltier device, the temperature sensor, or the like) can be specified by using the nucleic acid analysis device of the first embodiment. When this method is used, it is not necessary to set the temperature of a peltier device to a specific value as in the case of, for example, PTL 1 and it is possible to perform diagnosis of a device during nucleic acid amplification. Furthermore, it is possible to specify a cause part, and thus it is possible to promptly repair the device at low costs.

It is necessary to carefully perform failure diagnosis of the temperature adjustment performance. Therefore, to increase the accuracy of diagnosis, diagnosis is performed on the basis of the control signal levels of not only one cycle but a plurality of cycles. As a result, the accuracy can be increased.

In addition, by performing diagnosis by comparing the control signal levels of a plurality of (up to twelve in this embodiment) temperature adjustment units 14, the accuracy of diagnosis can be further increased.

Hereinbefore, the method of diagnosis for each temperature adjustment unit 14 by comparing the current control signal level to the peltier element 4 with the initial value has been described. However, the failure occurring in a common temperature adjustment mechanism other than each temperature adjustment unit 14 can also be diagnosed by using the diagnosis results of the plurality of (up to twelve in this embodiment) temperature adjustment units 14 illustrated in FIG. 1.

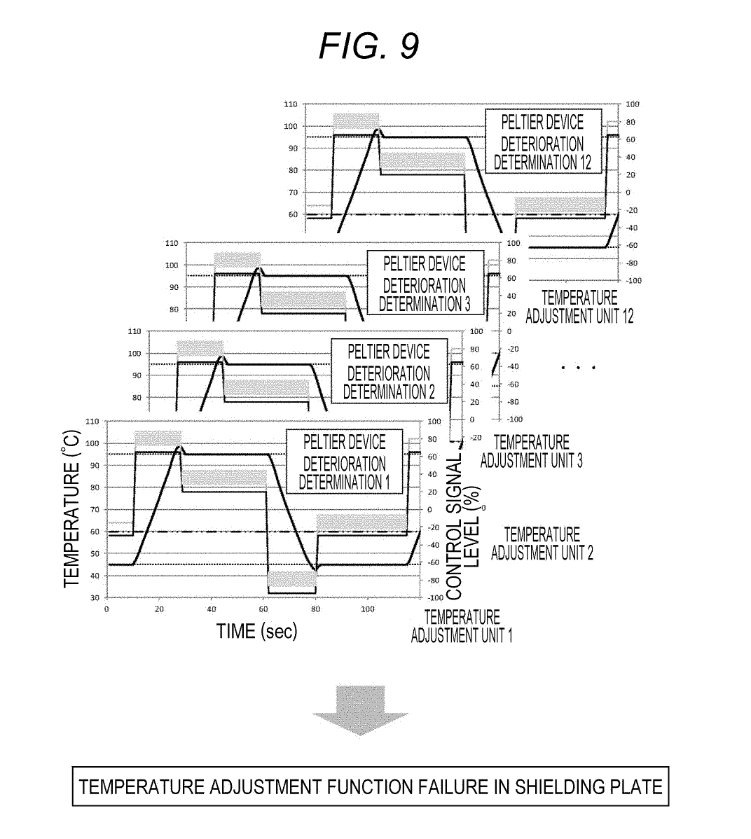

For example, it is assumed that the diagnosis result similar to that of the case of deterioration of the peltier device 4 of FIG. 6B is obtained from the plurality of (up to twelve in this embodiment) temperature adjustment units 14, as illustrated in FIG. 9. In such a case, the possibility that a plurality of peltier device 4 is deteriorated at the same time is significantly small and it can be diagnosed that failure has occurred in the temperature adjustment performance of the common temperature adjustment mechanism, that is, the shielding plate inner portion 11, of the plurality of (up to twelve in this embodiment) temperature adjustment units 14, and thus the atmosphere of the shielding plate inner portion 11 has been heated to a high temperature.

Since the device diagnosis method described above can be performed even in the middle of nucleic acid amplification, it is possible to perform diagnosis without a special time for diagnosis. However, the device diagnosis method can also be performed not only in the middle of nucleic acid amplification but also in the preparation period of waiting for analysis after the power is turned on.

When nucleic acid analysis is not performed, temperature cycling is performed in a state where the temperature of the shielding plate inner portion 11 reaches a predetermined temperature, the level of control signals for heating/cooling input to the peltier device 4 is monitored over all stages, and the monitored level is compared to the threshold. In this case, since the tube 10 is not installed in the temperature adjustment block 1, the heat capacity of the temperature adjustment block 1 is small and the behavior of the temperature is different from that at the time of measurement. Thus, a threshold other than that for determining failure in the nucleic acid amplification may be set. The relationship shown in FIG. 8 can be used as diagnosis criteria without any changes. This operation may be manually performed by a user or may be automatically performed at the time after the power is turned on or at the time at which the nucleic acid amplification is not performed.

### Second Embodiment

### [Configuration of Nucleic Acid Analysis Device]

FIG. 4 is a top view illustrating a schematic configuration example of a nucleic acid analysis device according to a second embodiment of the invention.

The nucleic acid extraction unit 33 includes a specimen installation portion 41, a centrifuge portion 42, a retreat chamber 43, a tube installation portion 44, an extraction reagent storage 45, a consumable part storage 46, and the like. Although detailed description of the nucleic acid extraction unit 33 is omitted, it has a function of removing unnecessary components from a specimen and extracting only nucleic acid necessary for analysis. The reagent mixing unit 34 includes an analysis reagent storage 47, a consumable part storage 48, a mixer 49, and the like. Although detailed description of the reagent mixing unit 34 is omitted, it has a function of mixing the nucleic acid extracted by the nucleic acid extraction unit 33 with reagents for analysis. The configuration of the nucleic acid analysis unit 35 is similar to that of the nucleic acid analysis unit 31 illustrated in FIG. 1. The nucleic acid analysis unit 35 has a function of analyzing nucleic acid, which is the final process. Conveyance of a tube between respective units is performed by a robot arm 50.

In the case of the nucleic acid analysis device 32 in which preprocessing units such as the nucleic acid extraction unit 33 and the reagent mixing unit 34 are connected to the nucleic acid analysis unit 35 as described in this embodiment, diagnosis can be performed in the middle of each process such as a preparation stage, a preprocessing stage, and an analyzing stage after the device is turned on.

An analyzer turns on the nucleic acid analysis device 32, sets up specimens, reagents, and consumable parts such as tubes, and starts analysis. At this time, in the case of the nucleic acid analysis device 32 having the nucleic acid extraction unit 33 and the reagent mixing unit 34 as illustrated in FIG. 4, diagnosis of the temperature adjustment unit 14 including the peltier device 4 and the temperature sensor 5 is started in the device startup stage (that is, the device preparation stage immediately after the power is turned on) and, failure (malfunction and performance deterioration), if any, can be detected at an early stage. When failure is detected, the device is temporarily stopped in a stage before preprocessing (mixing of reagents or the like) for analysis is performed on a specimen and repairing can be performed. Thus, the risks of wasting specimens can be reduced.

In a case where failure is not detected when the power is turned on, the device proceeds to a normal operation and starts preprocessing for analysis by the nucleic acid extraction unit 33 and the reagent mixing unit 34. Thereafter, even at the time after a nucleic acid amplification process is started, the diagnosis of the temperature adjustment unit can be performed at any time because it does not require special operations. Asa result, when failure is detected, the analysis is immediately stopped, and thus it is possible to prevent erroneous analysis results from being displayed. In addition, when a user wants to diagnose the performance of the temperature adjustment unit, diagnosis can be manually carried out after the device starts up as long as the device is in a state where the analysis operation is not performed.

### REFERENCE SIGNS LIST

1 temperature adjustment block
2 carousel
3 rotation shaft
4 peltier device
5 temperature sensor
6 photometer
7 shielding plate
8 excitation light irradiation window
9 fluorescence detection window
10 tube
11 shielding plate inner portion
12 heater
13 heat conductive sheet
14 temperature adjustment unit
31, 35 nucleic acid analysis unit
32 nucleic acid analysis device
33 nucleic acid extraction unit
34 reagent mixing unit
36 analysis processing unit
37 device diagnosis unit
41 specimen installation portion
42 centrifuge portion
43 retreat chamber
44 tube installation portion
45 extraction reagent storage
46, 48 consumable part storage
47 analysis reagent storage
49 mixer
50 robot arm

1. A nucleic acid analysis device comprising:
a temperature adjustment unit that adjusts a temperature of a sample containing nucleic acid; and
a temperature control unit,
wherein the temperature adjustment unit includes:
a holding member that holds a container containing the sample;
a temperature adjustment element that is installed in the holding member and adjusts the temperature of the sample;
a heat conductive material that increases thermal conductivity between the holding member and the temperature adjustment element; and
a temperature sensor that measures the temperature of the holding member,
the temperature control unit controls an level of control signals supplied to the temperature adjustment element, and
the temperature control unit performs diagnosis of the temperature adjustment unit on the basis of the level of control signals supplied to the temperature adjustment element.

2. The nucleic acid analysis device according to claim 1, further comprising a cover covering the temperature adjustment unit.

3. The nucleic acid analysis device according to claim 2, further comprising a temperature adjustment portion that adjusts the temperature inside the cover.

4. The nucleic acid analysis device according to claim 1, wherein the control signal level used for diagnosing the temperature adjustment unit is the level of control signals supplied to the temperature adjustment element at the time of temperature rise, temperature fall, or constant temperature maintenance of the temperature adjustment unit.

5. The nucleic acid analysis device according to claim 1, wherein the control signal level used for diagnosing the temperature adjustment unit is a combination of a plurality of levels of control signals supplied to the temperature adjustment element at the time of temperature rise, temperature fall, or constant temperature maintenance of the temperature adjustment unit.

6. The nucleic acid analysis device according to claim 2, wherein the diagnosis of the temperature adjustment unit is performed by comparing the control signal level with a predetermined reference value.

7. The nucleic acid analysis device according to claim 6,
wherein it is diagnosed that the temperature adjustment element has failed in a case where:
the level of control signals supplied to the temperature adjustment element is smaller than the predetermined reference value at the time of temperature rise of the temperature adjustment unit;
the level of control signals supplied to the temperature adjustment element is greater than the predetermined reference value at the time of temperature fall of the temperature adjustment unit;
the level of control signals supplied to the temperature adjustment element is smaller than the predetermined reference value at the time of maintaining a higher temperature of the temperature adjustment unit relative to the internal temperature of the cover; and
the level of control signals supplied to the temperature adjustment element is greater than the predetermined reference value at the time of maintaining a lower temperature of the temperature adjustment unit relative to the internal temperature of the cover.

8. The nucleic acid analysis device according to claim 6,
wherein it is diagnosed that the temperature sensor has failed in a case where:
the level of control signals supplied to the temperature adjustment element is greater than the predetermined reference value at the time of temperature rise of the temperature adjustment unit;
the level of control signals supplied to temperature adjustment element is greater than the predetermined reference value at the time of temperature fall of the temperature adjustment unit;
the level of control signals supplied to the temperature adjustment element is greater than the predetermined reference value at the time of maintaining a higher temperature of the temperature adjustment unit relative to the internal temperature of the cover; and
the level of control signals supplied to the temperature adjustment element is smaller than the predetermined reference value at the time of maintaining a lower temperature of the temperature adjustment unit relative to the internal temperature of the cover.

9. The nucleic acid analysis device according to claim 6,
wherein it is diagnosed that the heat conductive material has failed in a case where:
the level of control signals supplied to the temperature adjustment element is greater than the predetermined reference value at the time of temperature rise of the temperature adjustment unit;
the level of control signals supplied to the temperature adjustment element is greater than the predetermined reference value at the time of temperature fall of the temperature adjustment unit;
the level of control signals supplied to the temperature adjustment element is greater than the predetermined reference value at the time of maintaining a higher temperature of the temperature adjustment unit relative to the internal temperature of the cover; and
the level of control signals supplied to the temperature adjustment element is greater than the predetermined reference value at the time of maintaining a lower temperature of the temperature adjustment unit relative to the internal temperature of the cover.

10. The nucleic acid analysis device according to claim 6,
wherein it is diagnosed that the container is not installed in the holding member in a case where:
the level of control signals supplied to the temperature adjustment element is smaller than the predetermined reference value at the time of temperature rise of the temperature adjustment unit;
the level of control signals supplied to the temperature adjustment element is smaller than the predetermined reference value at the time of temperature fall of the temperature adjustment unit;
the level of control signals supplied to the temperature adjustment element is smaller than the predetermined reference value at the time of maintaining a higher temperature of the temperature adjustment unit relative to the internal temperature of the cover; and
the level of control signals supplied to the temperature adjustment element is smaller than the predetermined reference value at the time of maintaining a lower temperature of the temperature adjustment unit relative to the internal temperature of the cover.

11. The nucleic acid analysis device according to claim 6, wherein a comparison of the control signal level with the predetermined reference value is performed multiple times and the diagnosis of the temperature adjustment unit is performed.

12. The nucleic acid analysis device according to claim 6, wherein a plurality of the temperature adjustment units is installed and the diagnosis of each temperature adjustment unit is performed by comparing the diagnosis results of the plurality of temperature adjustment units.

13. The nucleic acid analysis device according to claim 12, wherein, when all of the diagnosis results of the plurality of temperature adjustment units show the same failure, it is diagnosed that a temperature adjusting function inside the cover has failed.

14. A nucleic acid analysis device comprising:
a reagent mixing unit that produces a sample by mixing nucleic acid and reagents in a container; and
an analysis unit that analyzes the sample,
wherein the analysis unit includes:
a temperature adjustment unit; and
a temperature control unit,
the temperature adjustment unit includes:
a holding member that holds the container containing the sample;
a temperature adjustment element that is installed in the holding member and adjusts a temperature of the sample;
a heat conductive material that increases thermal conductivity between the holding member and the temperature adjustment element; and
a temperature sensor that measures the temperature of the holding member,
the temperature control unit controls an level of control signals supplied to the temperature adjustment element, and
the temperature control unit performs diagnosis of the device on the basis of the level of control signals supplied to the temperature adjustment element and starts a process of the reagent mixing unit when the diagnosis result is normal.

15. A device diagnosis method for a nucleic acid analysis device comprising a temperature adjustment unit that adjusts a temperature of a sample containing nucleic acid and a temperature control unit,
wherein the temperature adjustment unit includes:
a holding member that holds a container containing the sample;
a temperature adjustment element that is installed in the holding member and adjusts the temperature of the sample;
a heat conductive material that increases thermal conductivity between the holding member and the temperature adjustment element; and
a temperature sensor that measures the temperature of the holding member,
the temperature control unit controls an level of control signals supplied to the temperature adjustment element, and
the temperature control unit performs diagnosis of the temperature adjustment unit on the basis of the level of control signals supplied to the temperature adjustment element.
